(19) United States
(12) Patent Application Publication
(10) Pub. No.: US 2021/0174280 A1
(43) Pub. Date: Jun. 10, 2021

(54) Systems and Methods for Efficient Cloud Migration

(71) Applicant: Thiruchelvan K Ratnapuri, Washington, DC (US)

(72) Inventor: Thiruchelvan K Ratnapuri, Washington, DC (US)

(21) Appl. No.: 16/706,923

(22) Filed: Dec. 9, 2019

(51) Int. Cl. G06Q 10/06; H04L 29/08

(52) U.S. Cl. CPC G06Q 10/06315; H04L 67/16; H04L 67/148; H04L 67/10

(57) ABSTRACT

The invention generally provides an efficient and effective method of migration for on-premises computing applications to a cloud computing environment. In one embodiment, the method involves automated or semi-automated discovery and planning of the scope of work by assessing which software applications and associated data are/should be under consideration for migration to the cloud. The software applications under consideration may then be assessed for suitability of migration to the cloud in view of various factors, including but not limited to, business goals, desired outcome, and cloud environment compatibility.

### PRIORITY CLAIM

This application claims the benefit of U.S. Provisional Application No. 62/924,137 filed Oct. 21, 2019, which is hereby incorporated by reference in its entirety.

### BACKGROUND OF THE INVENTION

In general, “cloud computing” refers to technologies that provide computational services, data access, and/or electronic storage that does not require end user knowledge of the physical location and configuration of the computing system that delivers those services. These are essentially generic “black box” service rental type solutions that simplify access and management of computer-based information, but without the requirement of significant investment in local computer hardware and other IT infrastructure. Currently, many organizations are transitioning on-premises computing platforms and associated applications to the cloud, which provides a service delivery model and a streamlined operating experience, including cost benefits such as improved computing services, and system scalability and flexibility. For example, such solutions typically reduce and/or eliminate altogether the need for substantial computing hardware purchases, periodic upgrades and in-house maintenance costs.

For those organizations that want to move from a conventional on-premises “source” computing environment to a “target” cloud computing environment, an evaluation process is necessary to identify the type of cloud computing environment suitable to meet their needs. Also key to successful transition is the creation of a plan or “roadmap” for moving or “migrating” services and applications from the source to the target cloud environment. This involves selection, creation and configuration of the most appropriate cloud platform environment and application of that architecture. It also may involve adjustment or reformation of existing software applications to make them more suitable for the cloud operating environment. This often includes prioritization and a determination of the dependency-based order of applications to be migrated to the cloud platform and the specific target architecture—to ensure an orderly and a substantially loss free service migration—as well as identification of any applications that cannot be moved to the cloud. In some instances, only a partial migration may be advisable.

Both the management and transparency of this process along with an advance understanding of the technical and financial requirements of this process accompanied by approval and customer buy in along with the availability of requisite in house resources are key to a successful and effective migration to the cloud.

Accordingly, it is desirable to address the concerns above to provide network users with systems and methods for the successful and efficient and transparent migration of local computing systems and/or environments to the cloud.

### SUMMARY OF THE INVENTION

It is therefore an object of the present invention to provide systems and methods that provide efficient migration to the cloud.

It is therefore also an object of the present invention to provide systems and methods that provide effective and transparent management of migration to the cloud.

It is therefore another object of the present invention to provide systems and methods for determining suitable cloud-based architectures for the successful and efficient migration to the cloud.

It is therefore also an object of the present invention to provide systems and methods for assessing, recommending and performing optional reformation of existing on-premises software applications to make them more suitable for the cloud operating environment as part of the migration process.

It is therefore also an object of the present invention to provide systems and methods that may prioritize the order of migration to the cloud based on pre-existing dependencies as part of the cloud migration process.

It is therefore also an object of the present invention to provide systems and methods that may prioritize the order of migration to the cloud based on customer specific priorities as part of the cloud migration process.

It is therefore also an object of the present invention to provide systems and methods that asses the suitability of source applications for cloud migration and may optionally recommend only partial migration to the cloud.

The present invention relates generally to computerized systems and methods, and in particular, to more efficient and improved computerized systems and method for evaluating, processing and migrating discreet computer networks and associated applications to the cloud.

According to one aspect, the invention generally provides an efficient and effective method of migration for on-premises computing applications to a cloud computing environment. In one embodiment, the method involves automated or semi-automated discovery and planning of the scope of work by assessing which software applications and associated data are/should be under consideration for migration to the cloud. The software applications under consideration may then be assessed for suitability of migration to the cloud in view of various factors, including but not limited to, business goals, desired outcome, and cloud environment compatibility. The systems and methods may include the step of analyzing source software applications under consideration for migration to determine target architecture and environment suitability (e.g., to a public, private or hybrid cloud architecture). This may involve recommendations for adaptation or modification for successful cloud-situated operation. A migration strategy is defined based on the accessing and analyzing steps. This allows a recommendation of readiness of the applications under consideration for migration to the cloud.

In some embodiments, the invention may be embodied as one or more of a series of executable code or electronic instructions in modules or other configurations for performing one or more of the steps or techniques described herein and stored on a computer readable medium such as a hard drive, jump drive, semiconductor-based memory such as SRAM or DRAM and/or an optical or magnetic storage disk, etc. In some embodiments, such instructions may be stored across a number of network coupled computers and carried out on such remote computing devices in concert to achieve the goals of the present invention. Any suitable memory or computer architecture may be used if desired.

In one embodiment of the invention, the process of planning the cloud migration after Discovery, involves Setting the Strategy, Scoring & Prioritizing, Instance Sizing/Typing, Grouping, Wave Assignment, and Reflection—though it is not necessary to perform those steps in that exact order.

One aspect of the present invention provides for a computer-based method for migrating source local computer network applications to a target cloud operating environment using a migration planning and assessment (MPA) application, comprising: assessing the readiness of the source local computer network applications for migration to the cloud at least in part through the use of the automated migration planning and assessment (MPA) application; discovering source local computer network applications that may qualify for migration to the cloud; based on the discovery step, creating a suitable target cloud architecture for applications selected for migration; prior to migration, preforming a planning analysis to facilitate a successful migration to the created target cloud architecture; and migrating selected applications to the target cloud computing environment based on the outcome of the planning analysis.

Another aspect of the invention provides for a computer-based system for migrating source local computer network applications to a target cloud operating environment using a migration planning and assessment (MPA) application, comprising an assessment module disposed on a computer for assessing the readiness of the source local computer network applications for migration to the cloud at least in part through the use of the automated migration planning and assessment (MPA) application; a discovery module for discovering source local computer network applications that may qualify for migration to the cloud; a cloud architecture creation module for creating a suitable target cloud architecture for applications selected for migration; a planning and analysis module for performing a planning analysis to facilitate a successful migration to the created target cloud architecture prior to migration and a migration module for migrating selected applications to the target cloud computing environment based on the outcome of the planning analysis.

Another aspect of the invention provides for a computer-readable medium including contents that are configured to cause one or more computing systems to migrate source local computer network applications to a target cloud operating environment using a migration planning and assessment (MPA) application, comprising the steps of: assessing the readiness of the source local computer network applications for migration to the cloud at least in part through the use of the automated migration planning and assessment (MPA) application; discovering source local computer network applications that may qualify for migration to the cloud; based on the discovery step, creating a suitable target cloud architecture for applications selected for migration; prior to migration, preforming a planning analysis to facilitate a successful migration to the created target cloud architecture and migrating selected applications to the target cloud computing environment based on the outcome of the planning analysis.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a generalized flow chart illustrating some of the steps involved with assessment and migration of certain assets to a cloud computing environment, in accordance with one embodiment of the present invention.

FIG. 2 is a more detailed flow chart of the method described in FIG. 1, which illustrates some additional steps involved in with assessment and migration of certain assets to a cloud computing environment, in accordance with one embodiment of the present invention.

FIG. 3 is an illustrative example of a questionnaire dashboard in accordance with one aspect of the present invention.

FIG. 4 is an illustrative example of a migration strategy planning dashboard in accordance with one aspect of the present invention.

FIG. 5 is an illustrative example of a readiness dashboard in accordance with one aspect of the present invention.

FIG. 6 is an example of a budget planning dashboard in accordance with one aspect of the present invention.

FIG. 7 is an example of another budget planning results dashboard in accordance with one aspect of the present invention.

FIG. 8 is an illustrative example of a discovery dashboard in accordance with one aspect of the present invention.

FIG. 9 is an illustrative example of a project planning dashboard in accordance with one aspect of the present invention.

FIG. 10 is an illustrative example of a planning dashboard in accordance with one aspect of the present invention.

FIG. 11 is an illustrative example of a task dashboard in accordance with one aspect of the present invention

FIG. 12 is an illustrative example of a risk calculation dashboard in accordance with one aspect of the present invention.

FIG. 13 is an illustrative example of an application priority dashboard in accordance with one aspect of the present invention.

FIG. 14 is an illustrative example of a server list in accordance with one aspect of the present invention.

FIG. 15 is an illustrative example of a dashboard showing the status of a migrated server in accordance with one aspect of the present invention.

FIG. 16 is an exemplary client work flow diagram illustrating a more specific example of the method described in FIG. 1 in accordance with one embodiment of the present invention.

FIG. 17 is an exemplary client work flow diagram illustrating a more specific example of the method described in FIG. 3 in accordance with an embodiment of the present invention.

FIG. 18 is an exemplary client work flow diagram illustrating a global overview in accordance with an aspect of the present invention.

### DETAILED DESCRIPTION OF THE INVENTION

The present invention is directed to systems and methods that can be utilized to evaluate, assess and efficiently configure and deploy enterprise computing applications to the cloud. The invention may be used or applied to a variety of contexts other than cloud migration, and, may include an architectural assessment, topology recommendation, reference architectures, application migration assessment, migration strategy and roadmap, and migration effort estimation, as well as execution and operational optimization functions, etc.

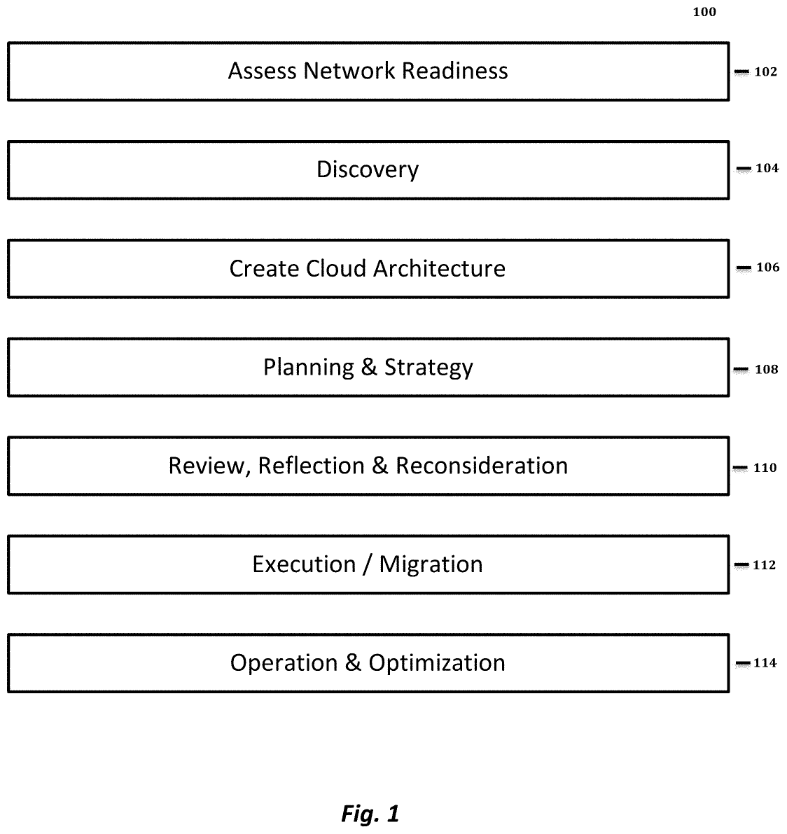

In high level terms, one aspect of the present invention may divide the processes of assessment, evaluation and migration into a series of steps or phases, and each phase may indicate the overall progression in terms of the assessment and planning process through various application or interface displays. This method is generally shown in connection with the flowchart 100 of FIG. 1. As shown, in one embodiment of the present invention, the process may include an assessment step 102, a discovery step 104, a cloud architecture creation step 106, a planning and strategy step 108, a review, reflection and reconsideration step 110, an execution and migration step 112 and an operation and optimization step 114.

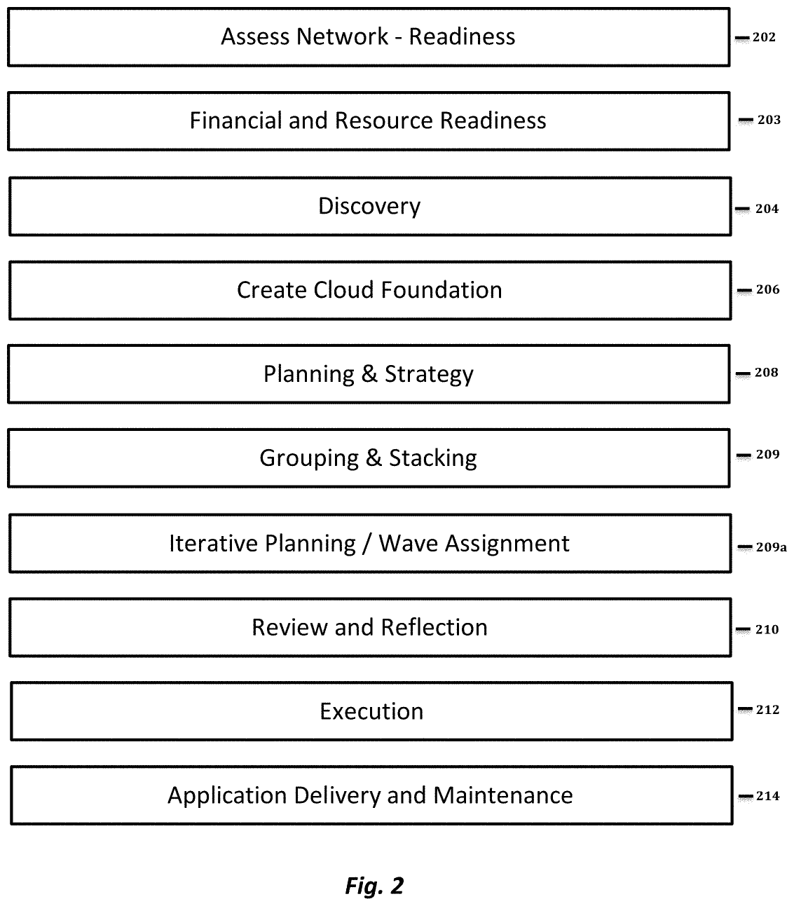

The flowchart 200 of FIG. 2 is a more detailed embodiment of the flow chart 100 shown in FIG. 1, wherein similar reference numbers refer to similar functionalities (e.g., 102 and 202 refer to the same or similar features) and wherein additional new uncorrelated reference numbers refer to more specific or additional features (i.e., 203, 209. 209a).

Assessment Stage 102 and 202 FIGS. 1 and 2.

At assessment stage 102 or 202, there is an initial assessment of the scope of work, and planning of the activities needed to be completed in order to provide the right level of consultancy to advise on migration services. In some embodiments, this may be considered a “readiness” assessment. This stage may establish the scope and schedule of assessing the cloud requirements of the source business computing platform, and further, identification of services and applications that need to be considered for, or excluded from, cloud migration. In some embodiments of the invention, prior to this stage, key users may be identified within the enterprise for initial decision making and plan approval. Time of the users as well as staff who will provide input regarding enterprise objectives and applications may also be assessed and secured. With this information, the scope of work is identified. For example, a planning workshop or seminar may be held with application stakeholders. In some cases, such a work workshop may cover:

An overview of offerings/platforms for the cloud;

Explanation of the methodology for cloud migration;

Validating the inventory of application artifacts with management and end users;

Arrive at the list of applications to be considered for migration.

For example, there could be a determination of whether the scope is only assessing a single application that needs to be software as a service enabled, or is it for moving the entire set of related (or unrelated) applications to cloud? Another relevant determination is whether the scope of work includes an evaluation of feasibility and desirability of a private cloud or public cloud system for an application, a portfolio, or an enterprise, and any other such questions necessary to define the exact scope of work. With the scope of work defined, a plan may then be created for the overall assessment exercise.

In some embodiments, this process may involve delineating all the activities that need to be performed, clearly indicating milestones, dependencies, and any potential bottlenecks, etc. The plan may also list the persons that need to be involved so that the delays are minimized. Additionally, it may include checkpoints to measure the progress and highlight any issues or risks in the process. This may be considered a measure of “readiness” for migration to the cloud.

After this initial interaction, the assessment process may begin with a proprietary suite of application programs such the SKYMAP and EQMIND products provided by Enquizit, Inc. the assignee of the present application, having a principal place of business at 7925 Jones Branch Dr, Suite 3100, Tysons, Va. Such migration planning and assessment software may be generally referred to herein as one or more “MPA” applications. Other proprietary modules for migration may include SKYINFRA and/or SKYBASE for generating cloud topologies required by clients, SKYPIPELINE for secure application delivery and migration as well as automated application delivery with SKYAPP, which are also provided by Enquizit, Inc.

By using the readiness assessments features in the MPA, the level of migration preparedness of a client that has an on-premises data center may be determined by looking specifically at enterprise/organizational readiness, budget, and resources. For example, it may provide an organization with certain focused questionnaires and/or discovery routines that look at migration readiness in terms of:

The level of executive support—are formal approvals and key conditions in place for a successful move to the cloud?

Discovery work—how much do you know about your existing assets; and what risks exist, where and why?

Migration planning—how much time and effort has the client put into planning and preparing for the migration?

“Cloud Foundation” preparation—how much groundwork has the client done for the design and creation of a cloud-based target environment This typically includes details regarding the type of cloud topology or architecture for the contemplated service hosting. This may be accomplished for example by using SKYBASE for generating cloud topologies required by clients.

Adjustments made to operate in the cloud—what changes, if any, has the client made to operations, policies, practices, and knowledge so a successful migration to the cloud can be expected or made more likely?

Security posture and needs—what are the clients security needs and how much thought consideration has been given to how those needs will be met in the cloud? This may include a DevSecOps analysis which may be applicable to both public and private networks, with potential emphasis on the interaction points between the two.

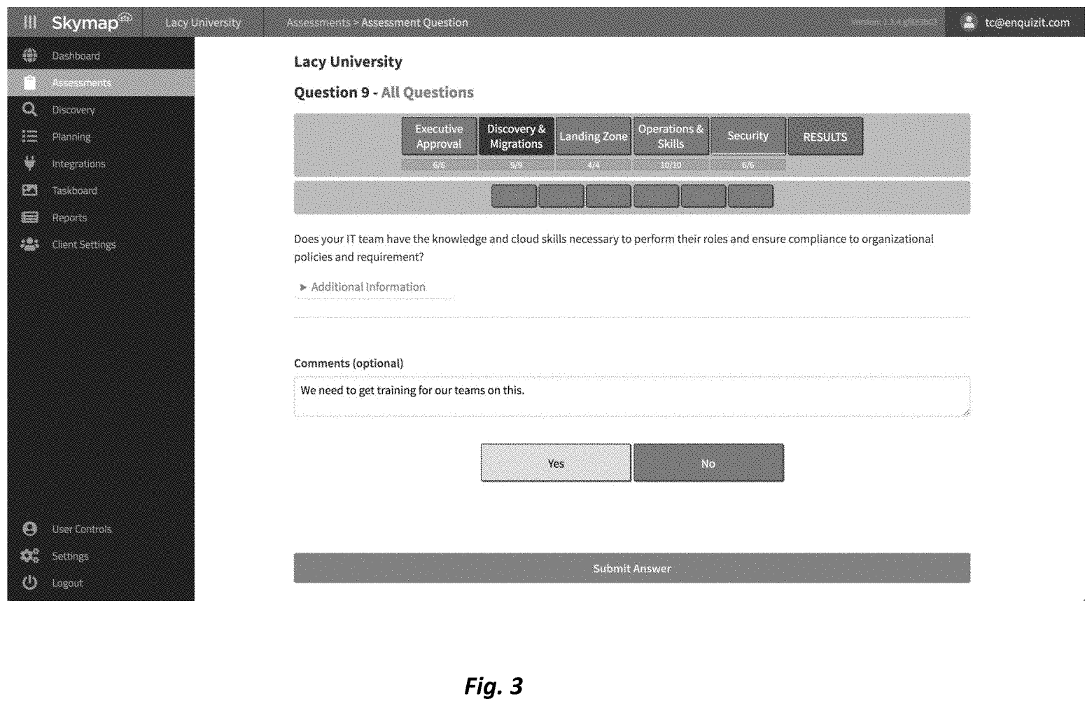

In certain embodiments of the invention, some of these questions may be answered through a series of auto discovery and assessment routines in the MPA suite and/or answers surmised by results of this process. An example of a questionnaire dashboard in accordance with one aspect of the present invention is shown in FIG. 3. One way this may been accomplished is by the MPA based on historical data from previously similarly situated migration projects. The results may be confirmed and/or modified and updated by enterprise stakeholders.

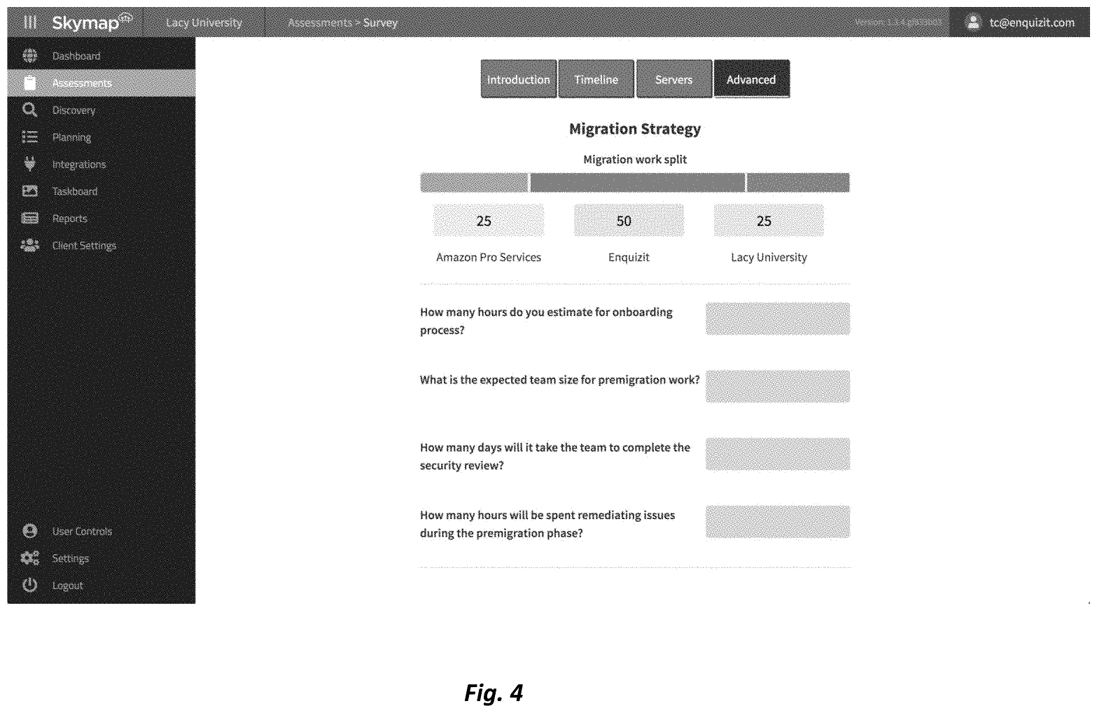

An example of a migration strategy planning dashboard in accordance with one aspect of the present invention is shown in FIG. 4.

The results of these inquiries may be compiled together to produce an indication of readiness such as a “readiness score” which evaluates overall organizational migration preparedness, with a maximum readiness score of 100%. By working through this readiness assessment process, the MPA of the present invention can provide insight, and identify any shortcomings, inefficiencies or gaps that allow for possible plan adjustment by targeting areas for improvement and thereby reduce the probability of mistakes and increase the likelihood of success. Clients are typically unaware of these issues prior to conducting the readiness analysis, which may, in many instances, call for remedial or corrective action.

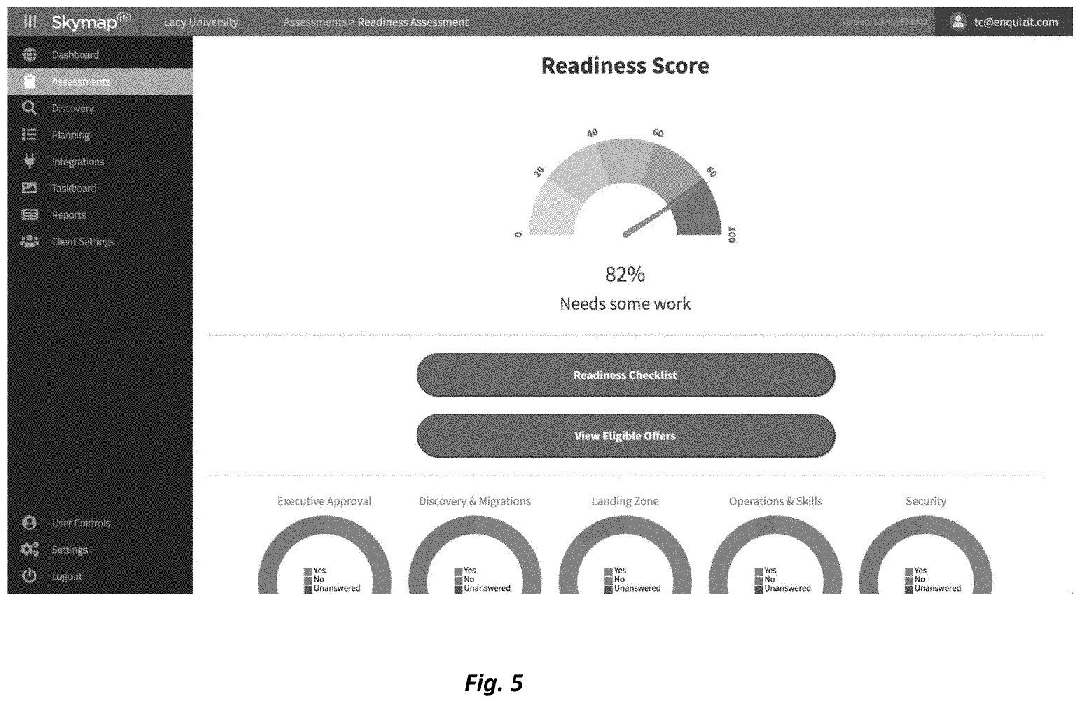

An example of a readiness dashboard in accordance with one aspect of the present invention is shown in FIG. 5, which illustrates an overall score and checklist options.

At this point, the results/deliverables resulting from the planning and assessment phase may be confirmed. This may include approval of the initially contemplated target cloud architecture, final initial identification of the assets to be moved, adjustment or exclusion of any existing applications and well as timing and end result of the migration process. This will help ensure that the parties involved clearly understand the process and result in terms of to avoid any expectation gap. At the end of this phase, one goal is to arrive at an agreed upon migration and services plan and a deliverables template provided to the client.

Financial and Resource Readiness Step 203

One aspect of the present invention also considers is an organization's migration preparedness by providing definitive estimates of the time and effort it will take to complete the migration process. This is shown as step 203 in FIG. 2. Some factors under consideration in this analysis may include:

Project duration—the approximate duration of the project;

Number of assets—the number of applications, total servers, and non-production servers

Servers that are challenging to migrate (e.g. AIX, Solaris, Oracle RAC, and deprecated technology)

Division of work—the division of labor between target environment provider such as AWS, and the partner migration team, and the client's staff;

Highly variable activities—estimates for activities like team on-boarding, pre-migration work, security reviews, and proactive remediation

After considering these factors, the systems and methods of the present invention may optionally calculate and provide certain budget and resource estimates, providing a recommended budget for the former (which may include any third party vendor charges, cloud migration partner costs, and client costs), and a computation of labor in man hours required for the latter category (which only includes hours from client staff). Clients may use this information to:

Provide support for adjusting the plan

Consider different funding and resource paths

Reduce resource bottlenecks

Increase the likelihood of success.

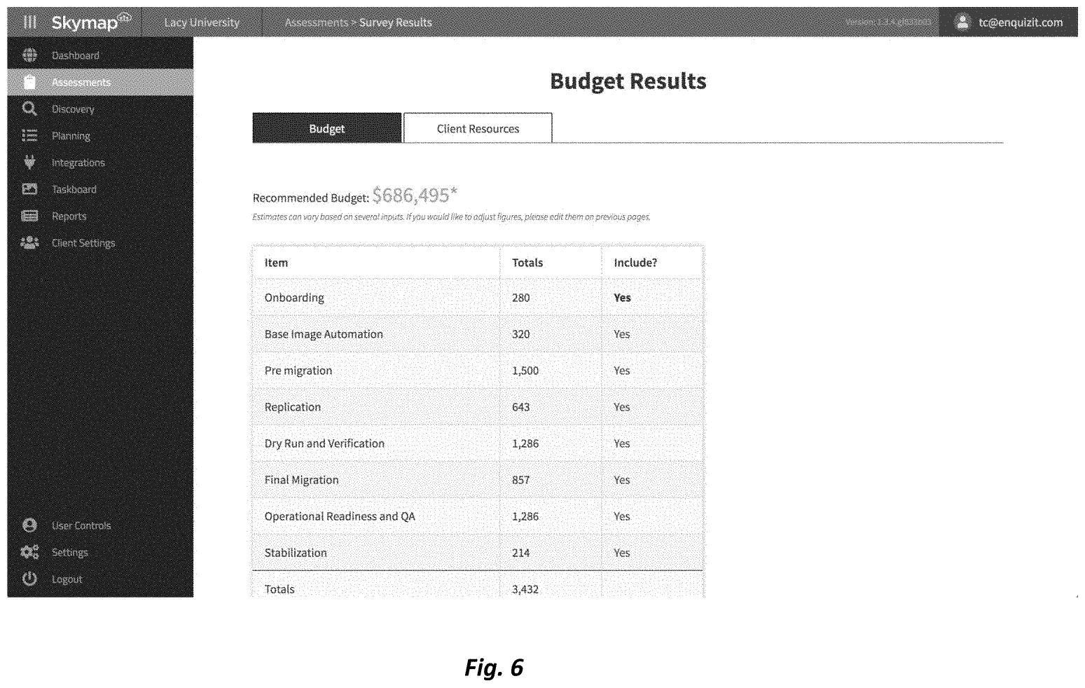

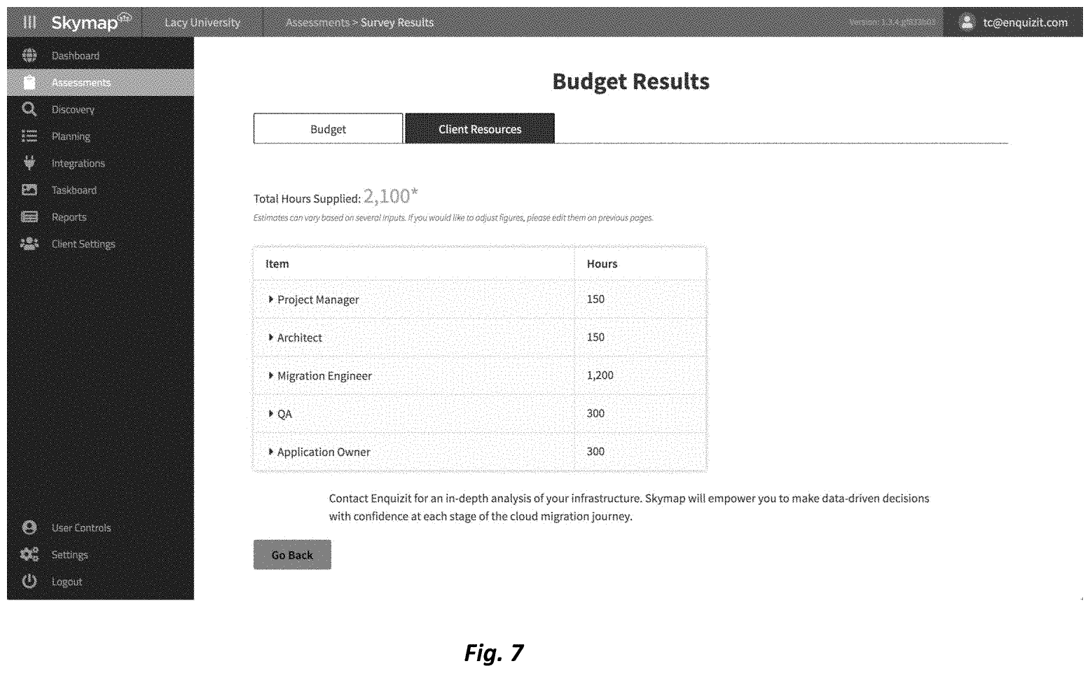

Examples of a budget planning dashboards in accordance with one aspect of the present invention are shown in FIGS. 6 and 7.

At the next stage, assessment functions endeavor to understand the target organization's landscape and requirements for the cloud and defining the goals and objectives for adopting the cloud. The process for assessment may involve looking at the application landscape from a technical stack perspective, as well as looking at the business domain model and its functionality requirements and any scalability needs. Application usage, statistics and trends may also be assessed. In some embodiments, some or all of these factors may be consolidated into a set of objectives for adopting the cloud. These objectives discovered and documented at this point of the assessment serves as a guiding force for the next phases. In the assessment process, the following is a non-exhaustive list of typical activities:

Understand high level business and technical drivers for moving to cloud—understand the business drivers for adopting cloud. This may involve assessing the agility and efficiency requirements that are desired for the business. The current enterprise goals for that particular line of business will also feed in to shape the cloud adoption objectives.

Evaluate the existing enterprise landscape and strategy and future needs—to recommend the right cloud solution that would have minimum disruptions, the existing enterprise landscape may need to be assessed, from a technical architecture, as well as from an infrastructure and systems point of view. Overall strategy of the portfolio, or its future needs also provide insights into how the applications within the portfolio are going to evolve.

Understand the current application usage context and trends—current application usage, its current issues, resolutions and workarounds, may inform the right cloud objectives that will aide in resolving the important issues. For example, an application having a relatively high of percentage of down time can be assessed to include a higher availability objective for a cloud, apart from the usual cost and performance objectives.

Define objectives for moving to cloud—the data above are analyzed in totality to arrive at a set of objectives for cloud adoption. These objectives should clearly indicate why does the enterprise want to move to cloud. These objectives also help determine Key Success Criteria in future phases, that will help in measuring the objectives and consequently, the effectiveness of the cloud.

Discovery Step 104 and 204 in FIGS. 1 and 2

After conducting readiness assessment at step 102 and after arriving at a determination that the selected target assets are in a condition for migration, certain embodiments of the present invention may install and/or deploy one or more automated or partially automated discovery modules on the source network (which may combine and/or couple automatic search functionality with manual discovery and user input) to determine elements and dependencies relevant to the migration effort. This is generally shown as discovery step 104 in FIG. 1. In some embodiments, this may partially or fully rely on, or be performed in conjunction with, or by third party discovery tools.

Such routines, which may be present in the MPA application suite of the present invention, among other things, typically assist in finding information on substantially all commonly used networks. Such tools may include, but are not limited to: RISC Networks, ServiceNow, Nessus, Device42, VMware, AWS Application Discovery Service, Excel, and others know in the art. This information may also include known application types (custom and COTS applications of all types—including database engines and utilities like Oracle Database, Informatica, Web Sphere, Microsoft IIS, Jenkins, SAP, Microsoft SQL Server, etc); servers and operating systems (mainframes, physical servers, virtual servers, operating systems, and clusters like z/OS, Windows Server, AIX, Redhat, Unix, iOS, Linux, etc.); and infrastructure (networking, storage, and other infrastructure assets like Cisco, EMC, IBM, F5, HP, etc).

In some embodiments, applications and servers may also be grouped into organized migration “stacks” (in a discovery interface, described in more detail below) that prevent interruption of dependent relationships and facilitates an error-free migration experience. Prior to this network users may input certain relevant operational constraints and/or details such as point of contact information, blackout periods etc.

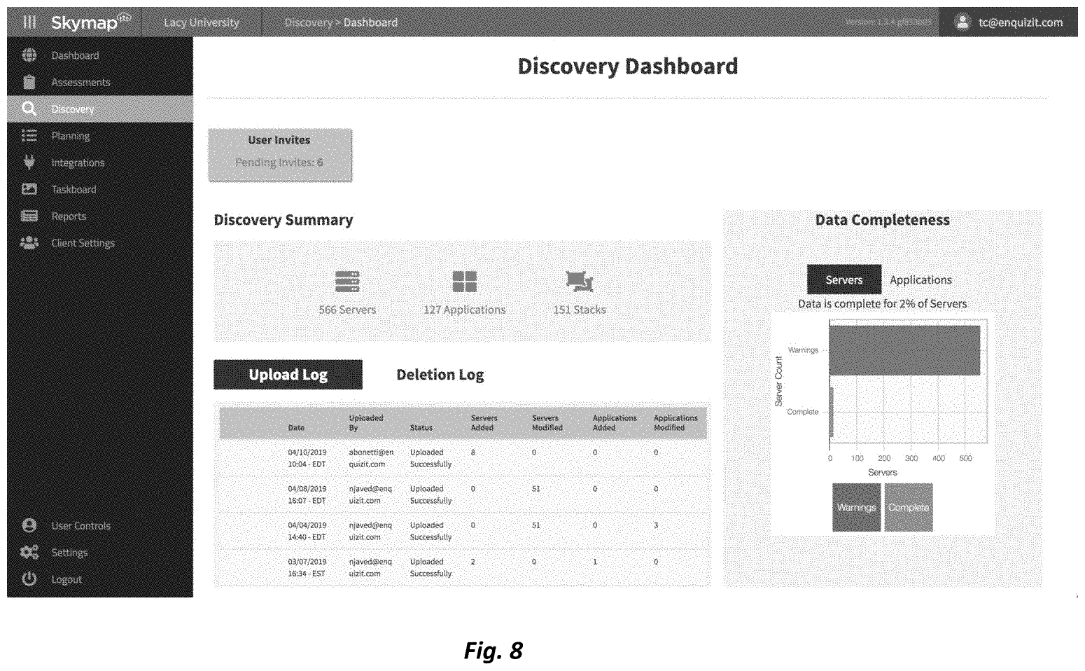

In some embodiments, discovery functions, control, management and results may be accessed and directed and viewed through a dashboard type graphical user interface (GUI) display. An illustrative example of a discovery dashboard in accordance with one aspect of the present invention is shown in FIG. 8.

As shown, the interface may present the user with various options, including the ability to upload certain server data, the ability to upload selected dependency data, and may include a “drag & drop” interface where the end user can enter and upload certain network configuration server inventory information, which may include template sheets. Although auto-discovery may substantially automatically locate servers and their dependencies, and may provide a graphical representation in the form of a chart or hierarchical perspective (not shown), it may also provide the ability to manually identify the same by entering application/server information or using a topology “drill down” tool (also not shown). Dependencies of interest may be securitized more directly in this way to ensure proper treatment during migration and flag it for potential monitoring going forward.

In some embodiments, manual entry may be the most direct or easiest way to include a small number of network assets. Furthermore, in some situations, manual entry also might allow user to identify and include “undiscoverable” assets that are not visible due to certain restrictions such as confidentiality/data sensitivity.

Analysis and Create Architecture Step 106 and 206 in FIGS. 1 and 2

The next stage is the analysis and architecture creation phase. This is generally shown as step 106 in FIG. 1 and step 206 in FIG. 2. This stage may include certain activities to evaluate the information acquired during discovery and apply a framework to arrive at a quantifiable metric (e.g., such as a “score”) that provide for an assignment of priorities to the discovered applications. This may include selecting a cloud provider such as Amazon, Microsoft, VMware, Softlayer etc. Subsequently, one or more cloud architectures may be prepared (or proposed) to establish an advance “blueprint” for a source organization's ultimate cloud environment based the selection of a provider and the acquired discovery data in view of customer goals and objectives.

In some embodiments, for the proposed cloud architecture(s), an application reference architecture may be created to model how applications will appear and operate on the target cloud platform in advance of migration (e.g., through iterative simulation, beta testing, etc.). This allows for further refinement, customization, and applications can then be updated to this reference architecture (once finalized) for subsequent efficient migration (not shown). This phase can optionally include any guidelines that are needed or desired to benchmark or prove any concept, design or method as well as evaluate the benefits of a particular cloud architecture or component.

The creation and selection of a desired target cloud architecture may be referred to as a “Cloud Foundation” preparation or solution. Aspects of the invention may provide such a solution, for example, through the SKYBASE application, to help build a foundation in the cloud for a customer that does not have a pre-existing one already. Such an application may provide certain topology templates in view of acquired discovery information in order to quickly and efficiently build a substantially turnkey and secure target cloud environment. Such a secure cloud environment can support substantially all or most compliance and business needs of the customer based on the data collected from the previous phases. Such an application may include one or more of the following features to get and running quickly and safely, including: Multiple zone deployment support for higher availability and reliability; Preconfigured Account Vending Machine template—provides substantially turnkey roles for operations and administration that streamline account creation and role definition for ecommerce or Internet storefront presence; Security management and monitoring tools to identify security threats and aid response; Regulatory compliance via service control policies, so your organization can be certain it's meeting the most common government compliance rules (e.g. FISMA, HIPAA and SOX); IAM directory integration to leverage any existing Identity and Access Management (IAM) infrastructure; Log aggregation and alerting to facilitate reporting, security, and to aid technical trouble-shooting and support regulatory compliance; Snapshot-based backups to make recovery or rollback quick and easy. Such systems may be integrated into or with cloud-based disaster recovery services to minimize data loss and recovery time; Centralized billing that supports activity-based costing (ABC) and usage-based or time-period billing to better manage and optimize operating costs; and an Automated Image Factory that manages the creation, hardening, approval and automated distribution of patched and updated machine images.

More specifically, in preferred embodiments, the computing infrastructure creation may be based on genericized topology creation software tools such as Infrastructure-as-Code (IaC) based solutions, which provide multiple benefits. For example, such an approach allows for advance creation and modeling and well as reduced cost and rollout time typically associated with custom based topologies. Moreover, such solutions are scalable and easily re-deployable which allows for a lightweight and flexible infrastructure framework that may be recreated quickly, consistently and reliably at a reasonable cost and that is within the control of in-house enterprise IT personnel. Such solutions are typically compatible with known application environments such as Java, Ruby or .Net applications, and are configured to provide a reliable cloud infrastructure for example, Amazon Web Services (AWS). Other features may include: Infrastructure-as-Code (IaC) based—can be deployed reliably many times; confidence that each SkyInfra cloud environments is nearly or mostly identical; Auto-scaling capable, allowing applications to handle more users or traffic while optimizing cost and performance; Include preconfigured server templates and for example, Amazon Machine Images (AMI's), which form the building blocks for environment consistency, fast cloud infrastructure buildout and low-cost maintenance; Integration with Relational Database Services (RDS), which may provide SQL Server, Postgres, Oracle and Amazon Aurora or other database services in the cloud; Supporting Network Infrastructure is also may be provided with routing, load-balancing, firewall/intrusion-prevention and the other AWS virtual infrastructure needed connect securely; A Versioned Artifact Repository that stores AWS machine images (AMI's) to support auditing and enable rolling back and restoration; Via federated logging and monitoring through certain open source code applications such as the ELK stack associated with the Amazon cloud computing environment, clients can monitor cloud operations for technical problems and/or security threats; Once configured for you, SkyInfra can be rapidly auto-deployed to your AWS cloud landing zone or Enquizit cloud SkyBase in as little as an hour; SkySuite compatibility, so SkyInfra works seamlessly with SkyBase, SkyPipeline, SkyApp and SkyMap, other Enquizit cloud turnkey products and services.

In some embodiments, the invention may include means to provide a ready-to-use cloud-based DevSecOps pipeline for Java, Ruby or .Net applications, providing a reliable automated DevSecOps pipeline at a fraction of the cost of a custom DevSecOps pipeline and in a fraction of the time. In some embodiments, this may be the SKYPIPELINE product from Enquizit, Inc. which is hereby incorporated by reference in its entirety configured to quickly deliver secure, reliable applications in the cloud, including tools for: Automated check-in, build and commit, so you know your code successfully merges into the correct branch; Automated source-code management, versioning and repository, which makes incremental enhancement, differential deployment and automated rollback in the cloud possible; Automated unit and functional testing to run the tests you've written to ensure your application functions as intended in the cloud; Automated static code analysis to ensure your source code is written with high quality and security; Gated commits and notifications to help ensure only clean code is merged into your main branch; An artifact storage repository so pre-built code, containers and other artifacts can be retrieved and deployed quickly; Automated multi-environment cloud deployment for up to four environments, so your code quickly and reliably progresses from development to production; Automated security vulnerability testing that checks for security weaknesses in your cloud-hosted application putting the “Sec” in DevSecOps; Federated logging and monitoring to capture and analyze activity across your application; Support for blue/green deployment, so your current application remains operational while your new one is being deployed and verified in the cloud; Service control policies to help you meet HIPAA, SOX, FISMA and other regulatory compliance requirements.

Planning and Strategy Step 108 in FIGS. 1 and 208 in FIG. 2

Planning the specifics of the actual migration to the cloud may be accomplished in any suitable manner in accordance with the spirit and scope of the present invention. However, one common approach is, after discovery, a strategy is decided upon followed by prioritizing, instance sizing and/or typing, grouping, wave assignment, and reflection—although it will be understood it is not necessary to perform all those steps, or perform them in this specific order.

For example, after enterprise assets have been discovered, a migration strategy may be determined that provides for the best path to the cloud for the identified asset(s). One way this may be accomplished is by using a cloud provider specific set of steps or procedures. one exemplary such procedure includes the Amazon “6R” framework, which may include some or all of the following: 1) Rehost—Simply migrate the computational asset without modification to the cloud with operating system and application(s) remaining substantially the same. Historically, 60-70% of servers are merely rehosted; 2) Re-platform—Migrate the computational asset, making some changes in the process. Typically, this include operating system, compilation environment or application upgrades. About 10% of servers are re-platformed; 3) Repurchase—Replace the asset with another product that provides the same or similar function, or transition to a software-as-a-service (SaaS) version. 4) Refactor—Rewrite or re-architect the computational asset, addressing weaknesses and optimizing for the selected cloud environment. 5) Retire—Decommission the asset because it is no longer needed/redundant. 8-9% of servers or related assets get retired; 6) Retain—Keep the asset on-premises or in the current data center; do not move to the cloud.

In some embodiments of the invention, to apply one of these strategies above to a server asset, a user may employ exemplary project planning dashboard such as the one shown in screen shot 7. With this embodiment, a user may expand the Discovery tab from the SKYMAP dashboard and click on Servers. From there, the user can select one of the discovered network servers, click on Basic Details, and then choose the appropriate migration strategy from the dropdown menu titled Migration Strategy. In certain embodiments, elements of artificial intelligence that learn over time may be used in order to make on or more migration recommendations here. Such learning may be based on other previous system (unrelated) migrations that allow elements of EQMIND evolve over time.

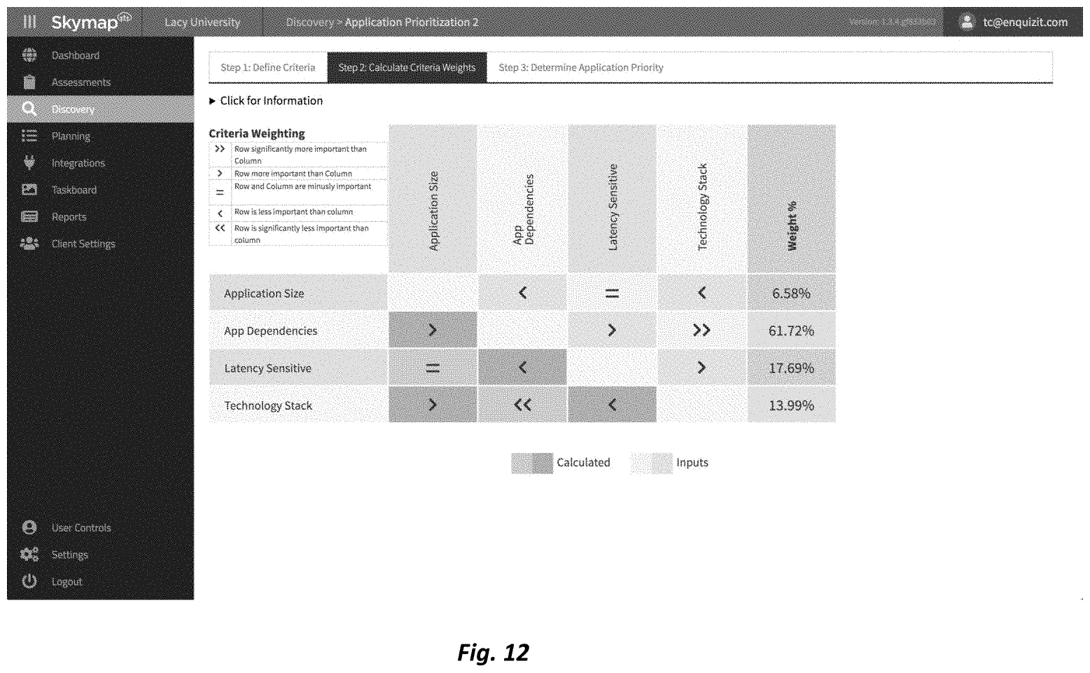

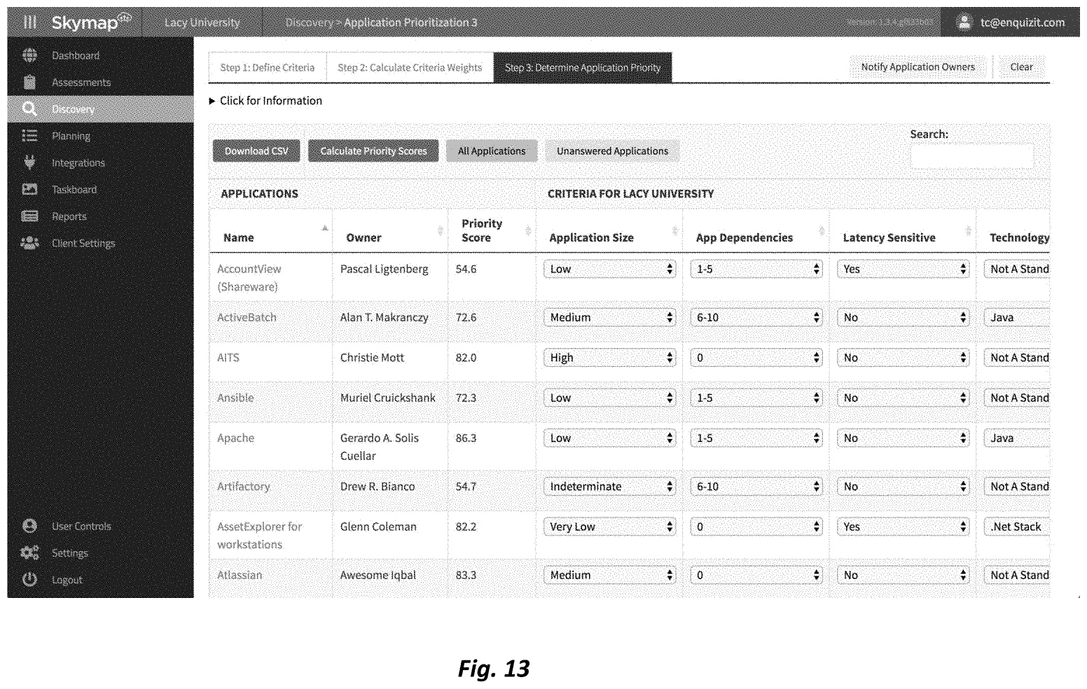

In some embodiments, after the system has applied the desired migration strategies to selected server assets, priority scores (or relative priority scores with respect to selected assets) may be assigned to the discovered applications. This may be based on certain weighting criterion shown in FIGS. 12 and 13. This may be accomplished by through a similar dashboard, using the Applications area is located under the Discovery branch of the navigation tree. By selecting the Basic Information button, a user may select an application from the list, and type in the values for various criterion in the respective box which are used to calculate a priority score, with higher scores indicating a higher priority application. This is shown in FIGS. 12 and 13.

Next, the system architect or IT user may select the cloud instance type that best meets the client's needs for the application(s) being hosted. In the Amazon ecosystem, this may be referred to as “EC2” type or Amazon Elastic Cloud Compute instance which is a web service that delivers secured and resizable computation capacity in the cloud. However, any suitable proprietary or open-ended system may be used if desired. EC2 instance types exist in various configurations and combinations like CPU, storage, memory and other common networking building blocks.

Typically, EC2 instance types provide a predictable and consistent amount of CPU capacity without any need for hardware. Such instances help facilitate, manages and launches the virtual servers according to customer requirements and provides high security, network, and manages storage process.

In one embodiment of the invention, EC2 selection may be made under the Discovery>Servers, tab, elect the server whose instance type desired, and then, under AWS Details, input the selected AWS instance type.

At step 209 of FIG. 2, another migration technique employed by embodiments of the invention may include an organizational technique known as “grouping.” After inputting instance settings, the grouping of servers, applications, and other assets together can facilitate the migration effort and reduce the risk of problems throughout the process. This may be done manually by enterprise IT personnel, automatically or semi-automatically by software routines of the present invention that may group assets according to customized or default grouping rules. In some embodiments, grouping may occur in an iterative fashion (as migration proceeds in certain tranches or “waves” as discussed below) or may be simulated in advance of committing to a particular grouping scheme. In performing grouping operations, the following are relevant considerations:

Risk

System/application criticality

Environment type (e.g. QA versus Prod)

Application, server, and infrastructure dependencies

Similar user community, architecture, and app ownership

User impact (number of users, user responsibilities)

Yet another migration technique employed by embodiments of the invention at step 209 include “stacking” of applications. Generally speaking, this is done for servers that share the same application and environment. Stacking in this way makes sense in the context of migration because of the efficiencies associated with a common or contemporaneous migration of substantially the same asset. This may be done manually by enterprise IT personnel, automatically or semi-automatically by software routines of the present invention that may stack assets according to customized or default stacking rules. In some embodiments, stacking may occur in an iterative fashion (as migration proceeds in tranches or “waves” as discussed below) or may be simulated in advance of committing to a particular stacking scheme. Embodiments of the present invention may automatically stack servers by application as default unless otherwise specified.

One way a server stack can be created by entering the Servers tab under Discovery, selecting a server, clicking on the edit button next to Stacks, and choosing the environment type(s). Multiple servers may be added to a stack under the Servers tab by selecting the checkbox to the left of multiple servers' host IPs, after which an Actions box will appear above the table. Select the Click to Select box, and then Add to Stack. Doing this will generate a popup box that will prompt you as to whether you would like to overwrite the selected servers' existing stack assignments, allow you to select application(s), and specify the environment(s).

At step 209a of FIG. 2, aspects of the present invention may offer iterative planning features through a staged or tranche approach. This may be considered and/or referred to herein as a “wave assignment” functionality. Because all source assets typically cannot be migrated simultaneously to the cloud, it is possible for some assets to migrate sooner than others, and thus able to assign assets to a migration in “waves”—which, in some embodiments may employ, fixed time-frames or schedules (e.g., two weeks, but not necessarily so) during which a certain number of servers are migrated in set order of succession. Migrating assets in waves not only enables iterative planning, but it also permits a migration team to continuously improve their migration process by assessing the success of how earlier waves transpired. Wave assignment may be based on numerous factors including: business priority, team and operational capacity, operational readiness and grouping factors.

The number of waves set for a particular migration may also be based on numerous factors such as the migration project start and/or end date, and migration wave duration. Waves settings can be applied in multiple ways, including single-server wave assignment, multi-server wave assignment, and the wave planning board.

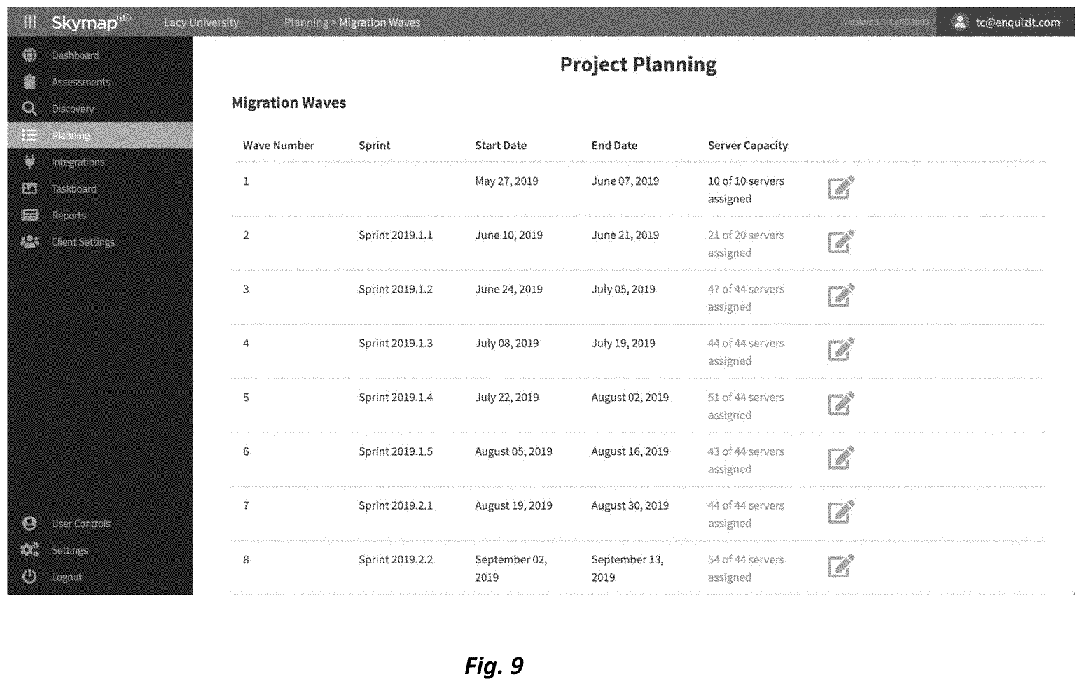

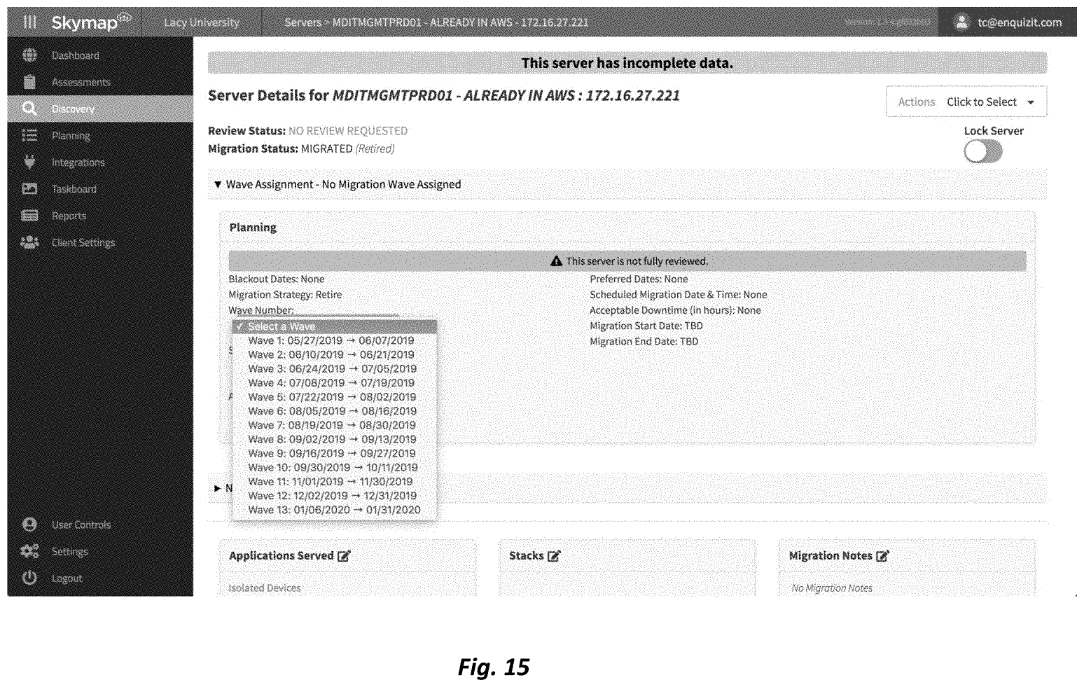

For example, in accordance with one embodiment of the invention a single server wave assignment may be initiated by selecting the Discovery>Servers tab, and then select a server from the list. In the Planning section, under Wave Number, select the dropdown menu and click on your desired wave. This is shown in FIGS. 9 and 15.

In accordance with other embodiments of the invention, a multi-server wave assignment may be initiated by Under Discovery>Servers tab, click on the checkboxes to the left of any server's host IP; above the search box on top of the table an Actions box will appear. Select the Click to Select button, and then Add to Wave. From there you can specify which wave the selected servers should be assigned to (overwriting any previous wave assignments for those servers, if they had them). Also shown FIGS. 9 and 15.

Certain embodiments of the invention may include a wave planning board. For example, by selecting the Planning>Wave Planning tab, a user can select Start New Wave Assignment and then drag applications and stacks to the correct wave number. Shown in FIGS. 9 and 15.

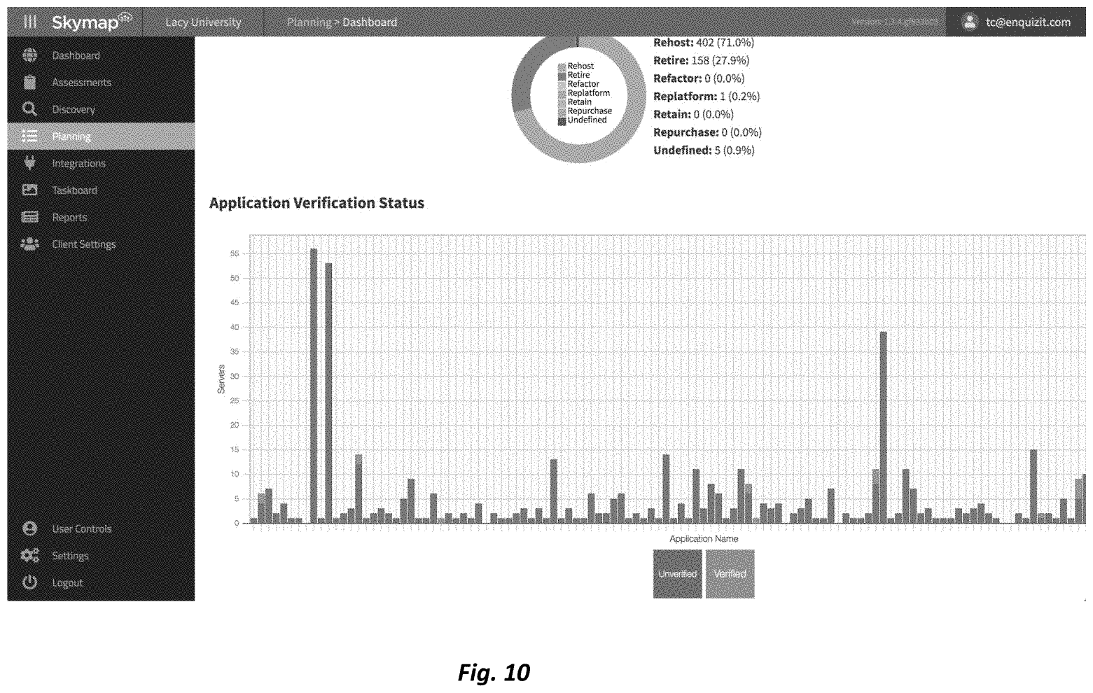

Wave assignment progress may be monitored through one or more summary dashboards. Regardless of how assets have been assigned to waves, in some embodiments the process may be considered incomplete until the selected assets have been reviewed under the Summary section of the Planning dashboard shown in FIG. 10. At the top left of the planning dashboard in screenshot 8 is an icon indicating the number of applications and servers that are ready, how many servers are equipped with a migration strategy, and how many servers are assigned to a wave. Applications and servers may remain in this unready state until their owners have reviewed them.

### Review, Reflection and Reconsideration Steps 110 and 210 in FIGS. 1 and 2

After servers and applications have been assigned to waves and stacks, the planning process 108 is substantially complete, and a final self-assessment phase, Reflection step 110 (210 in FIG. 2) may optionally be performed which promotes continuous learning and process improvement: specifically, migration teams may optionally conduct a retrospective regarding their to-date Assessment, Discovery, and Planning activities and may include one or more of the following considerations: periodic in house of third party review such as: Conduct migration team meeting to review work performed in the most recent wave, identify lessons learned, and determine what to change in future waves, to reap the maximum benefits from iterative planning Such reflection shares knowledge across the team and helps to identify opportunities to improve and the format of a retrospective may vary according to the business goals of the customer but may include: 1) summary of how migration progressed, including any major achievements or challenges such as what went well, what did not go well, what key lessons that were learned What should be changed or improved going forward. This feedback may be captured and recommendations incorporated into future work efforts. Such a review may be performed periodically such as once per wave, every other wave, milestone based, etc.

### Execution and Migration Steps 112 and 212 in FIGS. 1 and 2

Next at step 110, the source computing system is now considered ready for execution/migration. Generally, this means movement of the applications from the local source network into the target cloud environment in accordance with the migration plan. In most instances, the underlying source network remains intact and is decommissioned according to the transition order set forth in the migration plan. For example, this may be done in stages, as waves or completed, or, in some embodiments, after the completion of the entire migration process and testing on the new cloud-based network produces acceptable operational results.

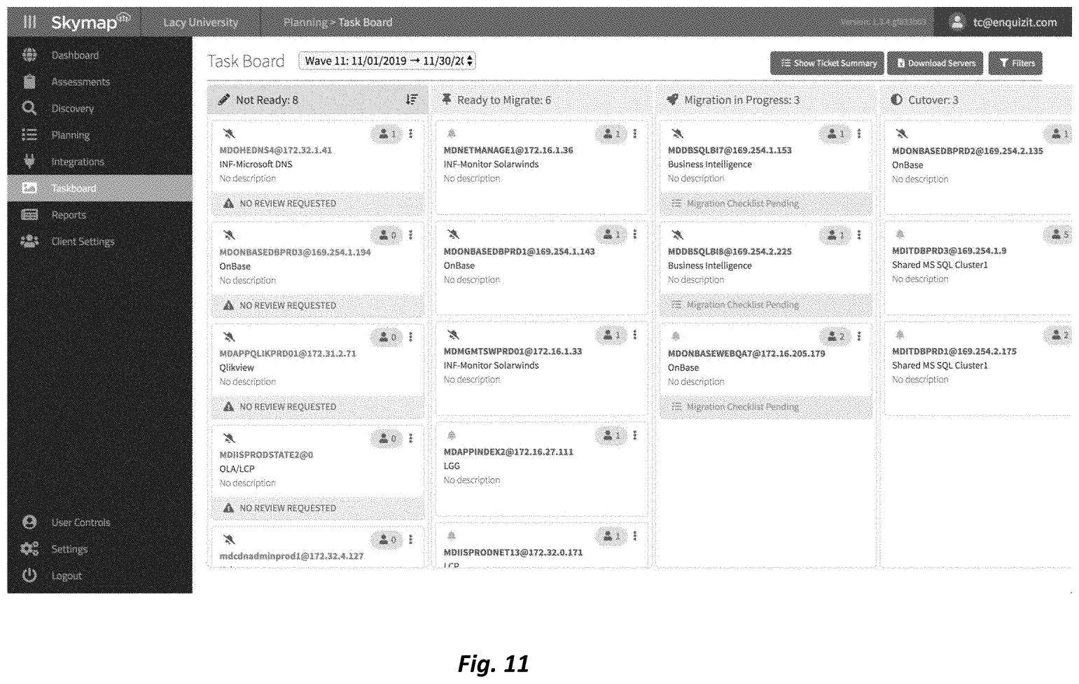

This process may be monitored though the task dashboard of FIG. 11. As shown by accessing the Task Board button in the navigation area, which leads to the Task Board section under Planning allows migration operators to track the status of your migration through a number of operational states of associated servers including: Not Ready; Ready to Migrate; In Progress; In Cutover (i.e., system is ready to go Live and waiting for the Administrator to change the DNS record); In User Acceptance Testing; Done.

In some embodiments, by default, the task board of FIG. 11. may illustrate the status of the first wave of migration (i.e., Wave 1), but users can click on the Wave 1 dropdown and select your other waves to view their server migration status. Notifications may be sent as server migration status changes, or as comments are added.

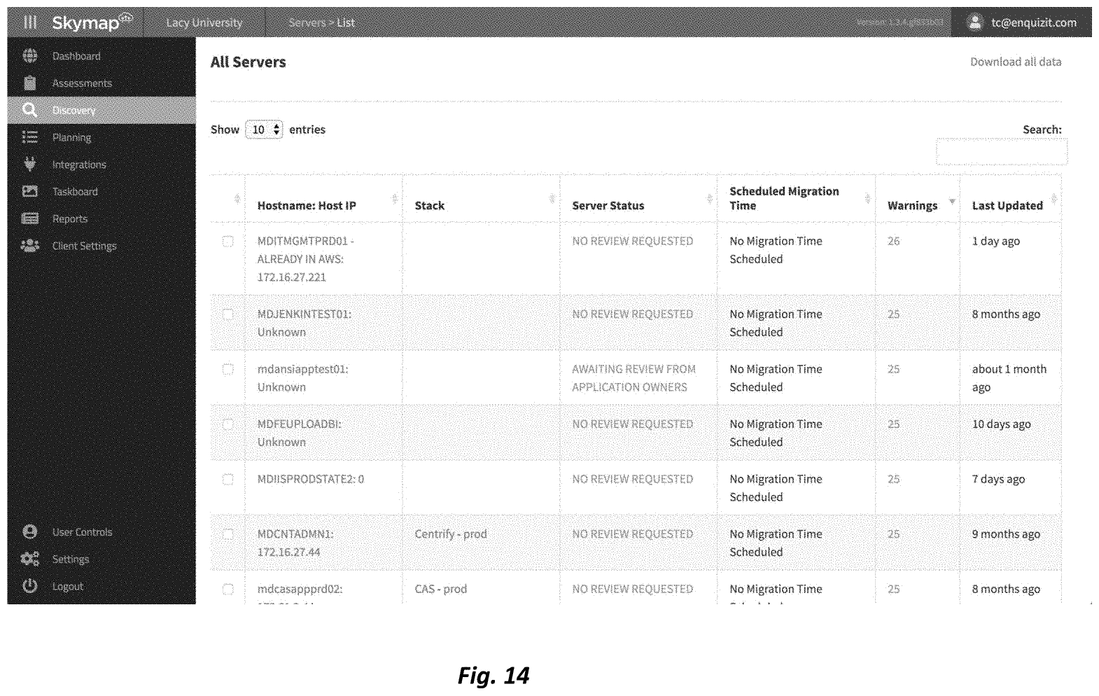

Users can also track migration via the Schedule page (located under Planning). There the scheduled migration date and time of each host IP/hostname may be observed. Shown in FIGS. 14 and 15.

### Operation and Optimization Step 114 and 214 in FIGS. 1 and 2

After the Execution and Migrations steps 112 and 212 have been performed, the systems and methods of the present invention have gathered and implemented substantially all network requirements, associated data points and policies as desired, it is often desirable to monitor the health of the target cloud network to ensure the system is operating as expected with respect to relevant operating characteristics such as policies; desired efficiency; security; stability and cost effectiveness. At steps 114 and 214, recursive algorithms may monitor these and other aspects of the network operation, provide reports updates or warnings to user of reduced or reducing performance, and alert for remedial action and, may in some embodiments, perform such measure automatically or semi-automatically depending on network configuration or user preference.

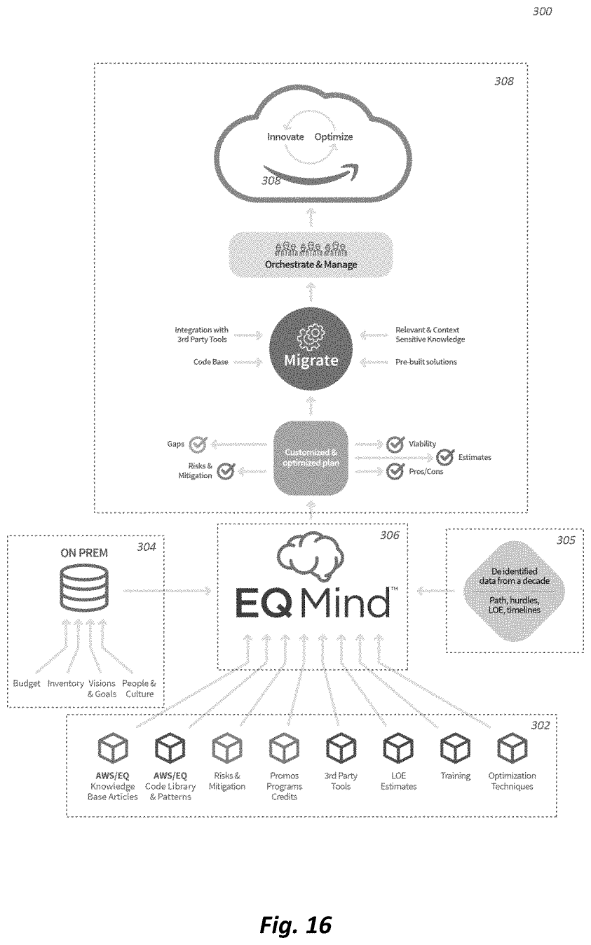

FIG. 16 shows a work flow diagram 300 in accordance with aspects of the present invention which include discovery analysis and diagnostic module 302, on premises enterprise information 304, legacy information from other similar previous migrations, assimilation and analysis module 306 and cloud optimization section 308.

Operations assimilation and analysis module 306, which, in some embodiments, may be the EQMIND suite of applications from Enquizit Inc., may combine and synthesize information and capabilities from modules 302, 304 and 306 to prepare the source computing network (and the organization's transformation plan as a whole) for migration to the cloud. For example, module 306 may call on information from module 302 such as knowledge base information, code libraries, risk assessment and other third-party tools, optimization techniques and others. Module 304 is customer specific information such as budget, inventory, migration goals information and may include “look and feel” templates from the existing on premises front end. Legacy module 305 represents a “lessons learned” database from previous similar migrations that may be brought to bear in order to optimize and streamline the current integration effort and prevent bottlenecks, migration inefficiencies and other undesirable outcomes. Operations assimilation and analysis module 306 may include any suitable recursive analysis or artificial intelligence program such as Amazon's Artificial Intelligence and Machine Learning for synthesizing input from 302, 304 and 305 in order to prepare the source network for migration to the cloud in module 308, which may operate in accordance with the flow charts of FIGS. 1 and 2.

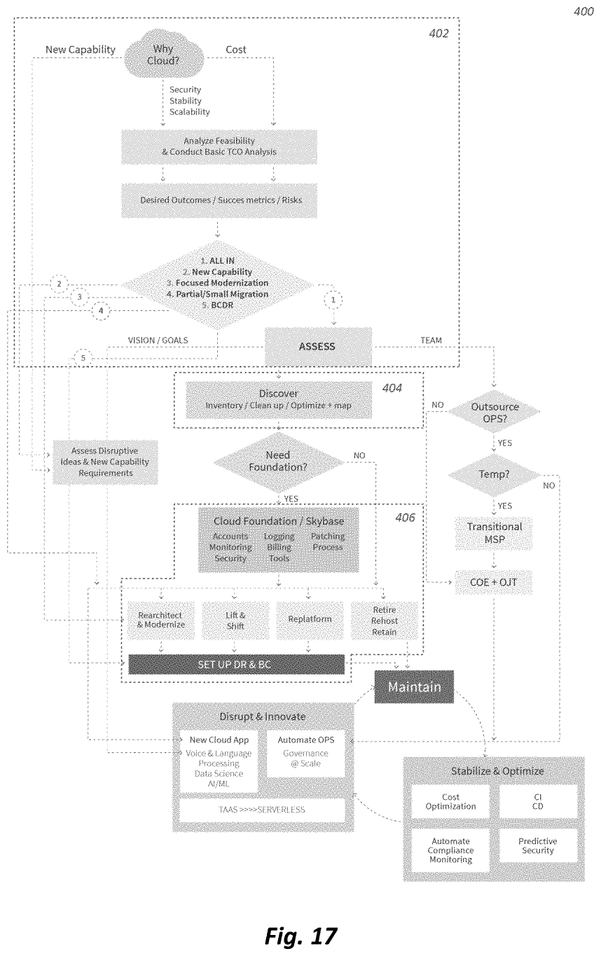

FIG. 17 shows a more detailed work flow diagram 400 in accordance with aspects of the present invention in which modules 402, 404 and 406 operate similar to the steps 102, 104 and 106 respectively, shown in FIG. 1 which include discovery analysis and diagnostic module 302, on premises enterprise information 304, legacy information from other similar previous migrations, assimilation and analysis module 306 and cloud optimization section 308.

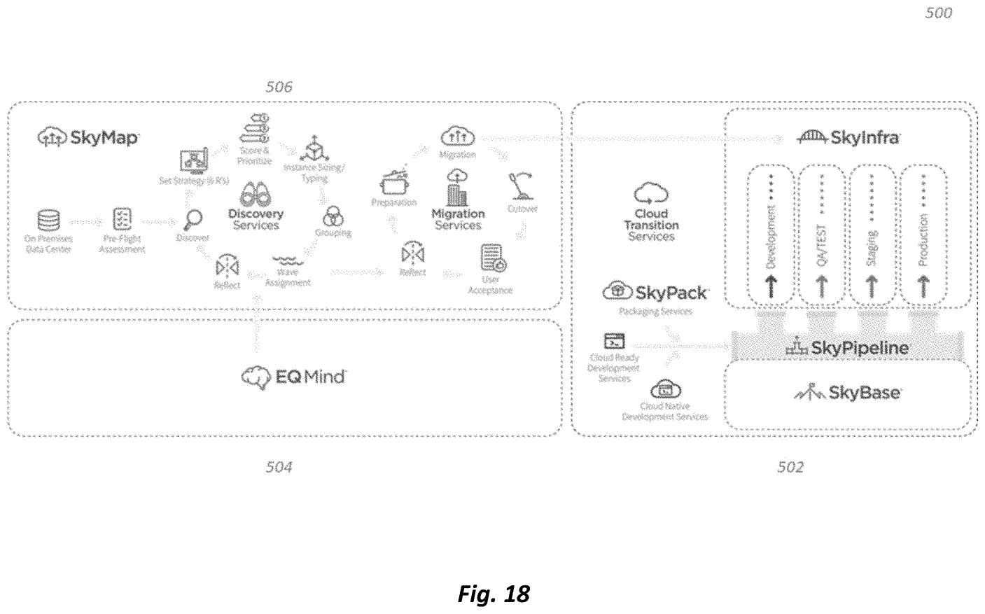

FIG. 18 shows an overall high level diagram of aspects of the present invention in which modules 502, 504 and 506 interoperate to perform the steps shown in FIGS. 1 and 2 as described above.

It will be understood that the foregoing systems and methods are merely illustrative, and are not meant to be comprehensive or necessarily performed in the order shown. Persons skilled in the art will appreciate that the present invention can be practiced by other than the described embodiments, which are presented for purposes of illustration rather than of limitation. For example. although the present invention is described in the context of cloud migration, the present invention is also useful for, and contemplates at its core, a full spectrum migration solution to numerous cloud service provider based solutions such as Amazon Web Service (AWS) in addition for use to improve Managed Service Provider (MSP) components which will allow clients to maintain their own cloud independently. The present invention will thus be much more than a cloud orchestration tool, it will take users from original readiness assessments all the way through to the MSP process and training users to use the tool self-sufficiently.

Persons skilled in the art will appreciate that the present invention can be practiced by other than the described embodiments, which are presented for purposes of illustration rather than of limitation, and the present invention is limited only by the claims which follow.

What is claimed is:

1. A computer-based method for migrating source local computer network applications to a target cloud operating environment using a migration planning and assessment (MPA) application, comprising:
assessing the readiness of the source local computer network applications for migration to the cloud at least in part through the use of the automated migration planning and assessment (MPA) application;
discovering source local computer network applications that may qualify for migration to the cloud;
based on the discovery step, creating a suitable target cloud architecture for applications selected for migration;
prior to migration, preforming a planning analysis to facilitate a successful migration to the created target cloud architecture
migrating selected applications to the target cloud computing environment based on the outcome of the planning analysis.

2. The computer-based method of claim 1 wherein migrating selected applications to the target cloud computing environment is based, at least in part on artificial intelligence.

3. The computer-based method of claim 1 wherein migrating selected applications to the target cloud computing environment is accomplished, at least in part, in waves.

4. The computer-based method of claim 3 wherein migrating selected applications to the target cloud computing environment is accomplished, at least in part, through grouping or stacking.

5. The computer-based method of claim 1 wherein target cloud architecture is optimized based on a review process before the migration is substantially complete.

6. The computer-based method of claim 1 wherein the readiness assessment is based on the organization as a whole.

7. A computer-based system for migrating source local computer network applications to a target cloud operating environment using a migration planning and assessment (MPA) application, comprising:
an assessment module disposed on a computer for assessing the readiness of the source local computer network applications for migration to the cloud at least in part through the use of the automated migration planning and assessment (MPA) application;
a discovery module for discovering source local computer network applications that may qualify for migration to the cloud;
a cloud architecture creation module for creating a suitable target cloud architecture for applications selected for migration;
a planning and analysis module for performing a planning analysis to facilitate a successful migration to the created target cloud architecture prior to migration
a migration module for migrating selected applications to the target cloud computing environment based on the outcome of the planning analysis.

8. The computer-based system of claim 7 wherein migrating selected applications to the target cloud computing environment is based, at least in part on artificial intelligence.

9. The computer-based system of claim 7 wherein migrating selected applications to the target cloud computing environment is accomplished, at least in part, in waves.

10. The computer-based system of claim 9 wherein migrating selected applications to the target cloud computing environment is accomplished, at least in part, through grouping or stacking.

11. The computer-based system of claim 7 wherein target cloud architecture is optimized based on a review process before the migration is substantially complete.

12. The computer-based method of claim 7 wherein the readiness assessment is based on the organization as a whole.

13. A computer-readable medium including contents that are configured to cause one or more computing systems to migrate source local computer network applications to a target cloud operating environment using a migration planning and assessment (MPA) application, comprising the steps of:
assessing the readiness of the source local computer network applications for migration to the cloud at least in part through the use of the automated migration planning and assessment (MPA) application;
discovering source local computer network applications that may qualify for migration to the cloud;
based on the discovery step, creating a suitable target cloud architecture for applications selected for migration;
prior to migration, preforming a planning analysis to facilitate a successful migration to the created target cloud architecture
migrating selected applications to the target cloud computing environment based on the outcome of the planning analysis.

14. The computer-readable medium of claim 13 wherein migrating selected applications to the target cloud computing environment is based, at least in part on artificial intelligence.

15. The computer-readable medium of claim 13 wherein migrating selected applications to the target cloud computing environment is accomplished, at least in part, in waves.

16. The computer-readable medium of claim 15 wherein migrating selected applications to the target cloud computing environment is accomplished, at least in part, through grouping or stacking.

17. The computer-readable medium computer-based method of claim 13 wherein target cloud architecture is optimized based on a review process before the migration is substantially complete.

18. The computer-readable medium of claim 13 wherein the readiness assessment is based on the organization as a whole.
